(19) United States
(12) Patent Application Publication
(10) Pub. No.: US 2021/0081810 A1
(43) Pub. Date: Mar. 18, 2021

(54) System and Method for Composing and Solving the Network-of-Machines Management Problem

(71) Applicant: Supported Intelligence, LLC, East Lansing, MI (US)

(72) Inventor: Patrick Lee Anderson, East Lansing, MI (US)

(73) Assignee: Supported Intelligence, LLC, East Lansing, MI (US)

(21) Appl. No.: 17/023,350

(22) Filed: Sep. 16, 2020

Related U.S. Application Data
(60) Provisional application No. 62/901,204, filed on Sep. 16, 2019.

(51) Int. Cl. G06N 5/02; G06N 7/00; G06Q 30/02

(52) U.S. Cl. CPC G06N 5/02; G06Q 30/0224; G06N 7/005

(57) ABSTRACT

A system and method for composing, solving and making decisions by creating a sequential decision problem concerning a network of machines.

### RELATED APPLICATIONS

This patent application claims priority to provisional patent application 62/901,204.

### BACKGROUND OF THE INVENTION

### Field of the Invention

Sequential decision problems (SDPs) are ubiquitous in life, commerce, and society. They involve the subject of the problem (the decision maker) observing information about the current state of the world, considering the likelihood of events occurring that depend on both random factors and on his or her own decisions, considering the potential rewards (including both costs and benefits) of making specific decisions in the current situation, and then making a decision in his or her own interests.

Sequential decision problems have been studied for millennia. Indeed, some of the oldest management decisions in human history are SDPs: when to plant a crop; when to sell your produce; how much food to put in storage; where to throw fishing nets; and—in extremis—when to abandon your land and migrate to a new homeland.

However, not all SDPs are mathematically solvable, and some that are theoretically solvable are practically intractable. Some well-known difficulties limiting the practical solutions available for SDPs include:

1: the “curse of dimensionality,”

2: the difficulty in composing the problem in practical terms,

3: the lack of a standardized language or manner of describing the problem,

4: the complexity of identifying every possible combination of state and action over multiple decision epochs,

5: the fact that some SDPs are not solvable within the domain of real numbers, and the amount of computing resources required to solve a SDP once composed, or to determine that it is not solvable using the system employed.

### DESCRIPTION OF THE RELATED ART

A classic sequential decision problem is known as the machine replacement problem. It involves a machine that deteriorates over time and suffers predictable obsolescence or termination of its useful life. In the classic version of the problem, the manager is given information on the likelihood of machine failure at each level of condition, the time each machine has been in service or since it has been repaired, the costs to repair or replace it, and the earnings that accrue to the manager if the machine works properly. Using this information, the decision at each time period is whether to repair or replace the machine.

In its classic form, this decision problem has only one state dimension (how long the machine has been in operation), no uncertainty, and a finite useful life of the machine. Given these restrictive (and usually unreasonable) assumptions, this decision problem can be composed mathematically and solved with the known method of backward induction.

Sequential decision problems formally involve 6 categories of information:

1. A set of states, which encompass the information available about the problem.

2. A set of actions available to the decision maker in the decision problem.

3. A time index, which sequences the states, actions, and rewards.

4. A reward function, which maps the states and actions to possible rewards.

5. A discount factor, which provides for comparison between current rewards and future rewards.

6. A transition probability function, which maps each combination of state and action to a likelihood of a subsequent state at the next time increment.

SDPs, while incredibly useful, have limitations. One problem that is frequently discussed is how to apply SDP techniques to replacing parts in a system.

The existing literature for the single machine replacement problem is extensive, and includes:

The classic Machine Replacement Problem (MRP) is well known and involves observed conditions (“states”) of a single machine with a predictable deterioration over time and known costs of repair and replacement. The classic approach is to formulate this as a sequential decision problem for a single machine, over a finite time period. In this form of MRP, each time epoch is recognized as a part of a sequence of such time epochs in which decisions are required, establishing a sequential decision problem.

One powerful mathematical construction of such sequential decision problems is known as dynamic programming. The term “dynamic programming” dates to Richard Bellman and his collaborator Stuart Dreyfuss. The term was popularized by the book authored by Bellman, Dynamic Programming, Princeton University Press, Princeton, N.J. (1957). Bellman himself studied the machine replacement problem in R. Bellman, “Equipment Replacement Policy,” Journal of Society for Industrial and Applied Mathematics, Vol. 3, No. 3, 1955, pp. 133-136.

In the classic formulation, the solution to the sequential decision problem is a policy minimizes costs (or maximizes production rewards) over that finite time period. The method is outlined in standard texts such as Bertsekas, Dynamic Programming and Optimal Control, Athena Scientific, Belmont, Mass., 2000. Because the problem involves a finite time period (in which all machines are assumed to be replaced, or the production process ceased), and finite costs and rewards, a solution method such as backward induction is always available.

The classic MRP has important restrictions. First, they require a finite life span for the problem. Second, the rewards and costs must be bounded real numbers. Third, there must be monotonic and certain depreciation of machines. Fourth, most can only handle predetermined and convenient distribtions of breakdowns (where convenient distributions are presumed to be non-degenerate, easily computable, and roughly consistent with physical deterioration of machines). Finally, it is common to additionally limit classic MRPs to exclude state dimensions outside of the conditions of the machines.

Numerous variations and improvements of the classic dynamic programming approach to the MRP have been proposed, and in many cases demonstrated. Many of these variations involve randomness in breakdowns, and hence the use of various probability methods in the calculation of estimated future costs and production rewards. In particular, the use of Bayesian inference rules (which are different from those of classical statistics), different sampling techniques, and different presumed statistical distributions related to the probability of a breakdown.

As with the classic MRP, because the problem involves a finite time period, bounded costs and rewards, and convenient assumptions about the underlying statistical distributions, a solution method such as backward induction is always available for most of these variations on the classic problem

The parallel machine replacement problem (PMRP) introduces the concept of what are commonly called “economically interdependent machines.” In the literature related to this concept, the nature of that interdependence is quite strictly defined. Common restrictions involve a linear combination of repair costs across multiple machines, homogenous machines, a budget constraint on total repair costs, and non-decreasing marginal costs.

In general, the PMRP literature extends the classic MRP methods by including costs across multiple machines operating in parallel. The general structure of the problem (in which machines are identified by condition), the goal of the problem (minimizing costs or maximizing production rewards), and the solution method (backward induction over a finite time period) are the same.

The PMRP methods reviewed rely upon very strong restrictions to achieve these results. These restrictions include a known and finite lifetime of a machine; a monotonically declining condition of each machine; the use of aggregate budget constraints or aggregate cost functions across all machines; the presumption of homogenous machines; and non-increasing marginal costs.

In general, the use of these very strong restrictions allows for useful but quite simplified—policies to be identified. Some other restrictions include the use of a No Splitting Rule that means all machines at a particular stage and age are either kept (or replaced) as a unit. Another potential restriction is the Oldest Cluster Replacement Rule which creates an optimal policy under the condition that a machine is replaced only when all older machines are also replaced. Childress, et al., Naval Research Logistics, 2005, pp 410-411. Other PMRP advances work by structuring the replacement cost function to create a deterministic PMRP of finite populations of economically interdepdent machines. P. C. Jones, J. L. Zydiak; and W. J. Hopp; Parallel machine replacement; Naval Res Logist 38 (1991). 351-365.

These applications of the standard PMRP again involve important restrictions. First, all of the restrictions discussed above for classic MRPs apply to standard PMRPs. Second, the examples reviewed in the literature of standard PMRPs can only handle simple linear combination of rewards and costs from individual machines; and involve budget constraints on costs across all machines. Finally, standard PMRPs in the literature reviewed commonly require homogenous machines for the solutions to function.

There is a need in the art for a method of composing and solving a set of sequential decision problems that do not fit within the restrictions listed above for the classic MRP and the standard PMRP. In particular, there is a need for a method to compose and solve a sequential decision problem involving both of the following:
(a) a network of “machines” or other nodes within a network, where the benefits and costs related to the operation of the network are not simple linear combinations of the benefits and costs of a set of individual machines, and where the machines are not homogenous, and where some of the “machines” are not subject to predictable obsolescence or degradation; and
(b) the application of the network to nodes of devices, installations, bases, cities, organizational units, and other concepts that can be modeled in a manner analogous to that of a “machine” that has important conditions or characteristics, and which requires inputs and produces outputs, and for which the operating conditions can and do change, and for which an action can be undertaken that is coordinated across a network of similar nodes or units.

### SUMMARY OF THE INVENTION

The present invention relates to a system and method for facilitating input of information from the user via the user input device; then defining, from the input information, a sequential decision problem with the subject being a network of machines or other nodes; and where this network-of-machines sequential decision problem involves the structure of the network and the costs and benefits arising from the network as a whole.

The network structure a graph of the network having a plurality of nodes and a plurality of edges, establishing the nodes in the network that represent each machine and the location of each machine within the network; and the edges between the nodes that represent directions, magnitudes, and other characteristics of the dependencies among the machines on the network.

At least one network state dimension representing at least one condition of the nodes on the network. At least one network management action that changes a characteristic of at least one of the nodes. A time index, the time index containing decision points available to the user, each decision point representing a point in time when the user selects a network management action. A network transition function mapping the probability of transitioning between the network state dimensions, given specific network management actions and the directions in the graph of the network. A signaling system signaling among the machines and the user communicating at least one of the network state dimensions. A network reward function mapping the network state dimensions, the network management actions, and a set of single machine output functions on the network, to a reward at each decision point that includes all costs and benefits related to the operation of the network.

A plurality of single machine sequential decision problems, each single machine sequential decision problem representing one or more machines on the network. Each has a set of state dimensions, representing conditions relevant to the relevant single machines, at least one single machine state dimension representing a condition of the relevant single machines. Each has a set of single machine actions, representing actions available to the operator of the network and affecting one or more single machines, with at least one shared operating status action, the operating status action determining the operating status of the network of machines. Each has the set of single machine output function mapping the single machine state dimensions and the single machine actions to the output of the machine in that state and under that network management action, the output representing the net benefits received by the operator of the network for each combination of single state dimensions and network management actions.

The plurality of single machine sequential decision problems all sharing many several parts. Sharing a discount factor representing the user's preference for rewards relative to time, and with the discount factor shared among all machines on the network and the time index contained within the network structure.

Taking the network structure and the plurality of single machine sequential decision problems and composing a separate network-of-machines sequential decision problem.

The single machine sequential decision problems each individually composed, error-checked and convergence-checked.

The programmed processor further composing the network-of-machines sequential decision problem by identifying beginning conditions of each machine in the network and beginning operation status of the network. Then taking at least one solution method selected from a list of available solutions methods, the list consisting of simultaneous network value function iteration, simultaneous network policy improvement, simultaneous network backwards induction, simultaneous network linear programming, simultaneous network integer programming, simultaneous network goal seeking with limits, simultaneous network iterative solving, simultaneous network goal seeking solving, truncated network solving, prioritized sequential machine solving, perturbation exploration, or composite sequential solving, the at least one solution method selected by the user or determined heuristically based on error and convergence checking among available solution methods for methods and selecting at least one method.

Then taking the set of solution method parameters (by user input or default settings), the set of solution method parameters consisting of convergence parameters and (when appropriate to the solution method) iteration limits, the solution method parameters used to find convergence testing results.

Next the programmed processor subsequently seeking a solution to the network-of-machines sequential decision problem by attempting one or more solution methods until the problem is solved, or until terminal condition is reached, the terminal condition being a user input condition such as a number of iterations or solution methods to attempt, or a further user input to stop or a user input condition specific stop condition is reached.

After seeking a solution, the programmed processor subsequently generating a summary of the solution, which includes a state-policy-value table, the state-policy-value table indicating, for each state, the action the user should select in that state and an indicated value representing the expected reward received by the user received for taking the indicated action; or alternatively, indicating the results of the attempts of finding a solution and the outcome of these attempts, which can optionally include information on the solution method, solution parameters, terminal conditions or iteration limits used in the attempts.

### BRIEF DESCRIPTION OF THE DRAWINGS

FIG. 1 is a block diagram of a computer system for executing a system and method for composing and solving the network-of-machines replacement problem.

FIG. 2 is a flow chart showing selected steps for composing and solving the network-of-machines replacement problem.

FIG. 2a is a flow chart breaking down inputs for composing and solving the network-of-machines replacement problem.

FIG. 3 is a chart showing requirements for the network structure

FIG. 4 is a chart showing composition of the set of single machine sequential decision problems.

FIG. 5 is a chart showing testing for parts of the network-of-machines replacement problem.

FIG. 6 is a flow chart showing selected steps for moving from network characteristics to a reported result for network-of-machines replacement problem.

FIG. 7 is a chart showing selected results that may be reported for the network-of-machines replacement problem.

FIG. 8 is an inventory table for an assembly line that assists in composing and solving the network-of-machines replacement problem.

FIG. 9 is directed graph showing a 5 node visualization of a 4 wheeled vehicle.

FIG. 10 is an inventory table for a 5 node visualization of a 4 wheeled vehicle.

FIG. 11 is directed graph showing a complex multi-feed assembly line.

FIG. 12 is an inventory table for a complex multi-feed assembly line.

FIG. 13 is directed graph showing a computer network.

FIG. 14 is an inventory table for a computer network.

FIG. 15 is a direct graph showing a naval network.

FIG. 16 a ribbon graph showing states, rewards and actions for a network.

FIG. 17 a line graph showing rewards for operational states and actions.

### DETAILED DESCRIPTION OF THE INVENTION

There remains a large class of sequential decision problems that contain elements of classic machine replacement problem. However, this class of problems extends beyond the boundary of a single machine, or a set of similar machines. Like the classic MRP and the standard PMRP, this class of problems involve “machines” (which can be physical devices, human-staffed operations, or computer software or hardware) that are subject to both predictable deterioration and unpredictable breakdowns.

However, there are at least three differences from between the large class of problems, and both the classic MRP and the standard PMRP:

1: The network-of-machines—not any individual machine, nor a set of individual machines—is the subject of the decision problem. As a result, the network of machines, and not a simple linear combination of individual machines, is the basis for both costs and rewards.

2: The information available to the decision maker is characterized by multiple state dimensions. Such information includes conditions of the network itself. This could include the readiness of the network as a whole to continue production; the operating characteristics of individual machines within the network that feed into, or take from these machines; and the amount of inventory already in the network. Further information optionally includes conditions that extend outside the network of machines, such as costs or prices.

3: The time period may be indefinite. In particular, since the focus (as defined below) is on the network, rather than on individual machines, the commonly-used presumption in the MRP and PMRP literature of a fixed and known time period of machine usefulness is not tenable.

These differences have significant consequences:

1: The network is a primary element of the decision problem. This introduces a mathematical construct, a directed graph, as an element that is not present in the MPR and (except in trivial form) in the PMRP.

2: Standard solution methods become unreliable. We cannot presume that these problems can be solved using the backward induction method. Although (particularly with strong restrictions) some problems could, the abandonment of the definite time period and known-finite-machine life restrictions make this class out of the reach of the standard methods used in the classic machine replacement problem, such as backward induction and, in some cases, linear programming.

3: Resulting decision rules will change. The additional state dimensions undermine, if not cause the rejection of, the policy rules such as “no splitting” that emerge from the PMRP literature. Furthermore, decisions that are identified as optimal in the classic MRP and the extended PMRP will, in many cases, not be optimal for the same machines when considered as part of a network.

4: A new system and method is required. The classic single machine replacement problem allowed for a mathematical formulation that could be solved directly, in many cases, with backward induction. The standard parallel machine replacement problem allows, with considerable restrictions, the same general method. Once the network becomes the subject of the decision problem, the standard formulation will not work.

Existing MRP and PMRP methods surveyed in the literature will not be adequate to the task of composing and solving these problems, which can be called “network management problems,” “network-of-machines strategy problems,” or “network-of-machines replacement problems.” In this class of decision problems, the individual machines are part of a multi-dimensional, indefinite time period sequential decision problem. In this class, the rewards and costs are dependent on the following:

1: The structure of the network of machines.

2: The condition of the individual machines, which we denote as the readiness of each machine.

3: The readiness of the network of machines, which depends on both the structure of the network, and the readiness of individual machines.

In network-of-machines replacement problem problems, the structure of the dependence of machines upon each other can form a network that can be represented by the mathematical construct of a directed graph and a network reward function. When formulated mathematically in a certain way, this network (the graph and the function) becomes an essential element of the network sequential decision problem.

Given all the difficulties noted above it is important to note some of the difficulties inherent to the network-of-machines replacement problem.

1: The network-of-machines replacement problem cannot be composed and solved using the standard methods defined here and found in the literature, in any of the following ways: as a set of individual MRPs; as a single PMRP; or as a set of individual PMRPs.

2: In cases where the “network” is simply a background factor, the “network” problem collapses to a set of individual decision problems with the background factor as a state dimension. This is properly seen as a PMRP, not a network-of-machines replacement problem, as defined here.

3: To properly compose and solve the Network-of-Machines Management Problem, a method must include the elements of the state identified above, and have an action set that encompasses both individual machine and network operations. Thus, there is a need for the invention described here.

4: Furthermore, the need for the invention does not change with better predictive data on breakdown probabilities, the availability of “machine learning” methods for predicting the likelihood of breakdowns, or the generic use of “big data.

5: Finally, care is taken to note that network-of-machines management problem is fundamentally different and harder than the standard PMRP, and that a set of economically interdependent machines (such as discussed above) are is not the same as a network of machines.

By using this system and method many of the restrictions that afflict classic MRPs and PMRPs are eliminated, at the cost of minimal additional restrictions.

The eliminated restrictions include requirement for a finite life span, ability to only consider state dimensions concerning conditions of the machines, requirement for simple linear combination of rewards and costs for individual machines (and the related budget constraints on costs across all machines restriction) and the requirement for homogeneous machines. However, network-of-machines replacement problem still requires bounded real number rewards and costs, monotonic and certain depreciation and a known distribution of breakdowns.

Additionally, network-of-machines replacement problem requires that the network rewards are bounded real numbers and that the total discount factor does not lead to exploding rewards and costs.

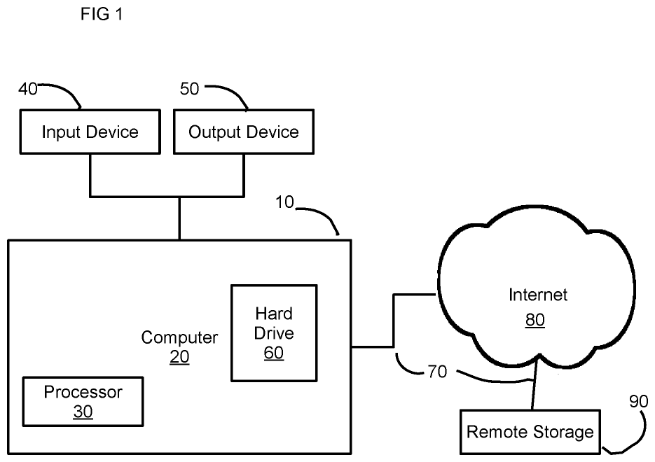

The disclosed system and method may be implemented by a variety of computing systems 10 (FIG. 1). The computing system 10 has a computer 20. The computer 20 has a processor 30, an input device 40, an output device 50 and a hard drive 60. The computer 20 is capable of executing computer software (not shown) that programs the computer 20 to evaluate decision problems, project a likely path and display that likely path to the user. The computer 20 may be a personal computer, laptop, desktop, smart phone, tablet, personal digital assistant, a networked server or any other similar device.

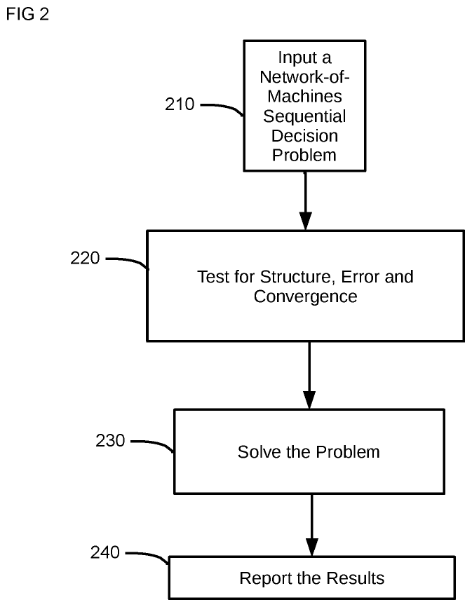

FIG. 2 shows an overview of the steps. A network-of-machines sequential decision problem is input 210, then tests are performed in 220, the problem is solved in 230 and results reported in 240.

Inputting the required elements for composing and solving network-of-machines replacement problems begins with two steps, that may be performed in either order or concurrently (FIG. 2a). One step is the composition of a set of single machine SDPs 200a and the other step is the specification of the network structure 210a, steps 220a, 230a and 240a are analogous to FIG. 2.

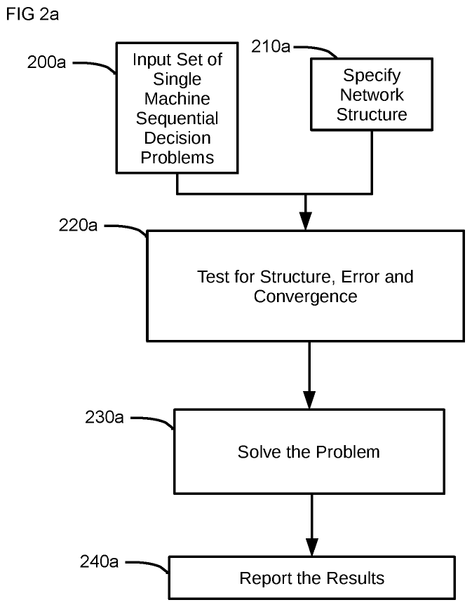

Specification of network structure is shown in FIG. 3.

Specifying the network structure 300 involves the specification of a network of machines, in the form of the following:

1: A directed graph of machines 310, which can be specified though a number of methods recognized in graph theory, including: a. directed graph, b. an adjacency matrix, or c. any other form or notation for a directed graph.

2: This graph must establish the location on the network (node on the graph), and the dependency, if any, on other machines on the network (the direction and other characteristics of the edge connecting the nodes).

Then a network transition function 310 is found for the network state dimensions. This function (which may be in the form of a (s2, s2, x) matrix, where s2 is the size of the network dimension of the state), maps the probability of transitioning from each state to each state, given the action x. Establishing this transition structure may involve using the multi-dimensional transition methods identified in U.S. Pat. No. 9,798,700. The entirety of U.S. Pat. No. 9,798,700 is incorporated by reference, however specific sections will be highlighted as applicable.

Then a signaling system 320 among machines and the network operator (operator not shown) is identified. The signaling system among machines and the network operator that encompasses the shared network state dimension. This could take the shape, in simple form, of the network operator monitoring signals from each machine on their operating conditions. It could also take the form of exchanging extensive information on condition, planned maintenance and other information, including cost and price information.

Then at least one action 330 within the shared action set across all machine-specific SDPs that determines the operating status of the network of machines.

Furthermore, a network reward function 340, which may take the form: NR(s, x)=NRF(s, x; MO; graph); where “MO” is the machine output as noted below.

NR(s, x) is network reward in state s given action x.

s is the state at the current time, where s is a member of the previously discussed: S={s1, s2, s3, s4}.

x is the action at the current time, where x is a member of the previously discussed X={a1, a2, a3, a4}.

MO=MO(s, x, graph)=the machine output of all machines on the network.

graph is the set of nodes and edges between the nodes, together with the magnitude and direction characteristics of the network, which is a practical application of the mathematical concept of a directed graph and an essential part of the structure of the network.

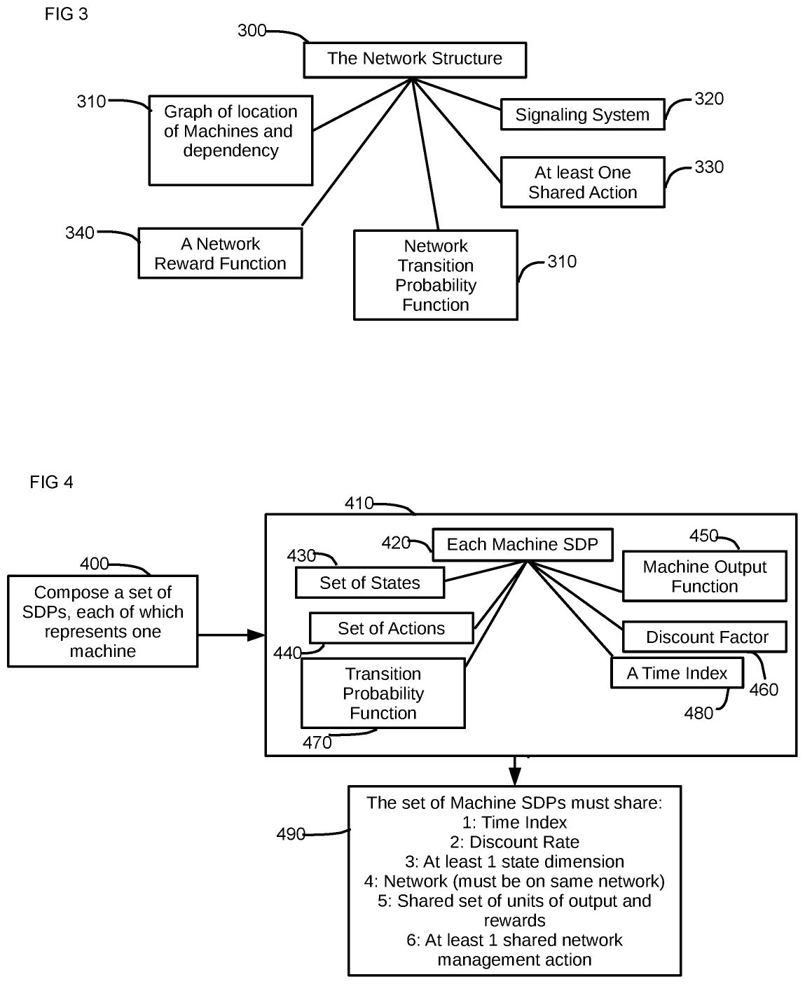

Composition of a set of single machine sequential decision problems 400 is shown in FIG. 4.

In the set of sequential decision problem 410 each represents one machine 420, and each of which have the following required 6 elements:

1: A set of states 430, which encompass the information available about the problem. For this network-of-machines replacement problem, the state dimensions will be shared across all “machines,” and with the network. For this problem, the state space is necessarily multi-dimensional, as at least one state dimension must include the characteristics of the network as a whole, and at least one dimension must include a characteristic of the machines on the network.

A representative state space is the following 4-dimensional space: S={s1, s2, s3, s4}, where s1 is the inventory at each machine, s2 is the operating state of the network, including all machines, s3 is the condition of machines on the network, and optionally the condition of the network itself, and s4 is prices or demand and supply conditions.

2: A set of actions 440 available to the decision maker in the decision problem. For this network-of-machines replacement problem, the action set must be consistent across all “machines,” and with the network. The action set must include at least two elements: an “operate” action in which the network operates without user intervention that would stop it from functioning; and an “intervention” action, in which the network manager intervenes in some manner to repair, improve, adjust, pause, stop, resupply, refurbish, or replace devices on the network. A representative action set is the following: X={a1, a2, a3, a4} where a1 is “stop and replace all machines”, a2 is “stop and replace machine set A”, a3 is “stop and replace machine set B”, and a4 is “operate.”

3: A machine output function 450 for each machine or device on the network, which maps the states and actions to output, rewards, or costs for each individual machine. This machine-specific output function must include elements of the shared state and action spaces for the network problem. Furthermore, the output function for each machine must satisfy certain conditions, as noted under the “Testing” step.

A representative machine output function, for machine number 1 on a network, could take the following form: MO1=MO(S, X, graph, position) where MO1 is the output on the network from machine 1, given state S and action X, expressed in the units and dimensions of the state space, graph is the graph of the network, and position is the position of machine 1 on the network.

4: A discount factor 460, which provides for comparison between current rewards and future rewards.

5: A transition probability function 470, which maps each combination of state and action to a likelihood of a subsequent state at the next time increment.

6: A time index 480 containing decision points available to the user, each decision point representing a point in time when the user selects a network management action.

Additionally, the composed SDPs 490 must include the following shared elements:

1: A shared time index. This may be arrived at by use of a conversion factor or other way to align different time rate problems to a single time index.

2: A shared discount rate.

3: At least one shared state dimension for the condition of the network. This dimension could be as simple as a logical variable for “operating” or “not operating,” or be much more complex and include multiple conditions for the operation of the network and its individual component machines.

4: An indication of a position of each machine (as defined within this application) on the same network, which may be accomplished by a reference in the specification of the network structure identified in a separate step.

5: A shared set of units of output and rewards, which could be achieved by the adoption of conversion factors.

6: At least one network management action. A network management action is an action that changes a characteristic of a node such as a repair or replacement.

Here, each “machine” can be a physical machine with parts, as in the classic machine replacement problem; or a device or system that involves physical parts as well as software, hardware, and network elements; or a human-staffed operation such as a base or ship or supply operation or other operations whose activities and status can be modeled as a “machine” for the purposes of composing an SDP of this type.

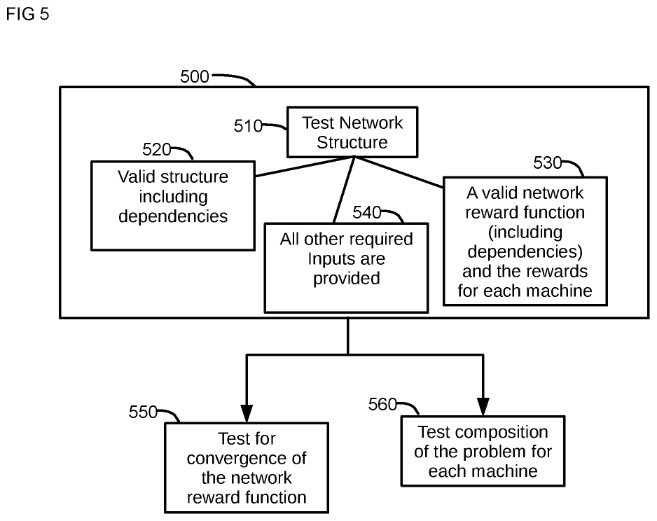

Having determining the single machine sequential decision problems and the specification of the network structure, there is testing phase shown in FIG. 5.

In the initial tests 500 the network structure is tested 510 by validating the structure 520, validating the network reward function 530 and checking that all other inputs are provided 540.

The valid structure 520 of the network must include identified dependencies among the machines.

The valid network reward function 530 which is based on the structure of the network (including dependencies reflected in the graph of the network) and the outputs arising from each machine, as well as any costs related to the management actions.

The presence of all required inputs is checked in 540.

Two different convergence checks may be performed. A convergence of the network reward function test 550 may be performed, or in the alternative a convergence check for each individual machine SDP may be performed 560.

This can take the form of the testing for errors and convergence identified within U.S. Pat. No. 9,798,700. In some cases it may be preferable to compose and error-check (or test) the individual problems, but not to convergence check the individual problems. In other cases the network reward function 530 is not convergence checked, but the individual sequential decision problems are convergence checked. In complicated problems or circumstances both the network reward function 530 and the individual sequential decision problems may be convergence checked.

The test for convergence of the network reward function 550 may be performed using an analogous test as in U.S. Pat. No. 9,798,700 for the whole network.

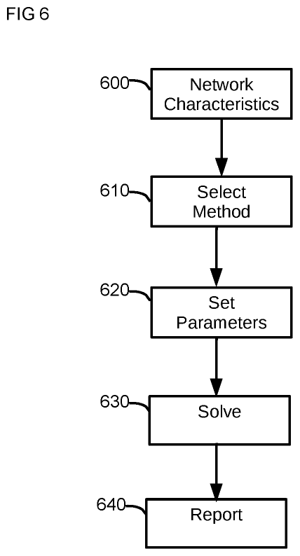

Sequentially solving the problem is shown in FIG. 6.

Once composed and checked as described above identify the characteristics within the network 600, set parameters for the solution method 610, select a solution method 620, begin solving the network-of-machines problem 630, using one of the methods described below.

1: Identify characteristics within the network 600 the original shared state, and machine-specific state, characteristics within the network. This could be done with any of the following protocols:

A: Set at a specific step in the Inventory Table (discussed later) for a machine selected by the user as the benchmark, and use the same step for all other machines, and select a starting state increment for other shared dimensions (such as, for example, prices and conditions of the machines). Similarly, a user-selected starting step (which may not be the first in an Inventory Table) could be the “initial step” selected.

B: Continue for all state dimensions, including the machine-specific dimensions. This protocol could be preferred for a network that has already been managed, and for which the user's prior knowledge could be utilized to shorten the solution time required. Set an arbitrary initial state for use with one of the solution methods listed below. For example, the initial state dimensions could be set at a user-specified typical operating situation. As an example, the first inventory step for all machines, and “new” condition, could be the original shared and machine-specific state characteristics for a production network. Alternatively, the initial state could be set arbitrarily and made the default initial information set for one of the solution methods identified below.

C: Foreclosure of specified states. This protocol could be preferred for smaller networks, or networks where little prior knowledge exists. Foreclose, at the direction of the user, a subset of the possible states, forming a new set of states that is smaller. Using this subset, select an initial step, or consider all available steps and remaining states, as stated above.

2: Allow the user to select a solution method 620 selected from among the list of solution methods below. Provide for a prioritization of methods, which would establish a default method, and optionally a prioritization of methods that would identify the first method to be tried, and at least one subsequent method to be tried, based on the following:

A: The time horizon

B: The size of the state, including the number of dimensions and the number of increments along each direction

C: The number of actions

D: The structure of the network, including the number of “feeder” lines and the number of edges or nodes.

Solution methods that are available to the user to be selected 610 include:

A: Simultaneous Network Solutions. Use the tentative information set for each machine as an initial iteration of the value function for the entire network. Solve for the entire network and all the machines within it from that initial point, subject to the solution method limits, using one of the following algorithms: Value function iteration (“VFI”), Policy improvement (“PI”), Backward induction, Linear or integer programming, or related algorithms, Goal-seeking with limits or iterative or goal-seeking algorithms.

B: Truncated Network Solutions. Evaluate the tentative information sets for all machines. Truncate one or more state dimensions. (For example, truncate the operating time for all machines on the network to an amount equal to the shortest operating time of any machine.) Re-set all information sets to be consistent with that truncation. Solve from that re-set point, subject to the solution method limits, using one of the methods listed here.

C: Prioritized Sequential Machine Solving:

Use the tentative information set fir all machines as an initial iteration of the value function for the network. Solve sequentially among machines or partitions of machines, using a priority sequence established by the network operator, subject to the solution method limits, using one of the algorithms listed here.

D: Perturbation Exploration. Use the tentative information set from all machines as an initial iteration of the value function. Perturb user-selected machines, or all machines on the network, from that set point to seek improvements in the value function, using one of the algorithms listed here.

E: Composite sequential solving. Form the network management problem as a composite of two network control problems, each of which could be a parallel-machine, single machine, or network-of-machines problem. Solve for the innermost portion of the composite problem, using one of the Available Solution Methods listed here. Use this solution as the initial iteration for the value function of the outer portion of the same composite problem. Solve that problem in the same manner. Optionally, use this composite solution as an initial iteration, and repeat a composite solution starting from a new starting point. Repeat if improvements in the value function are significant, using the value function iteration or policy iteration method listed here.

3: Set the parameters for the solution method to be used 620, which will include:

A: Convergence parameters and iteration limits, which apply to solution methods that use iterative calculations.

B: The results of the testing for convergence

Default settings for these parameters will, in the absence of user inputs, automatically select these settings.

4: Solve 630 for each machine and for the network of machines, using one of the solution methods identified below. Continue the solution actions until one of the following occurs:

A: A solution is found that satisfies the solution criteria; or

B: A terminal condition is reached, which could include a user-selected condition such as the number of iterations in the sequence above; or

C: A user-initiated stop or condition-specific override is initiated.

If a solution is not found using these steps, cease the solution efforts, and inform the user of the failure to solve, and do not proceed forward until the user has had the chance to review the information set that has been presented, and make changes as he or she selects.

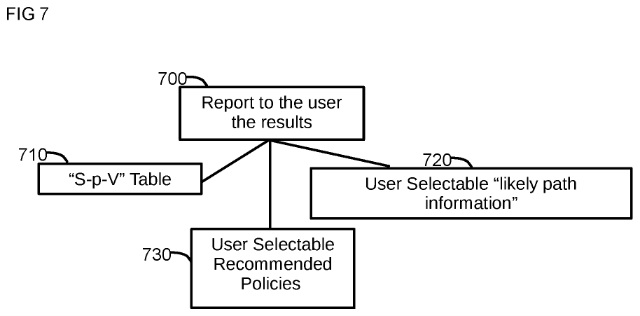

5: Collect and report the results 640 (some options shown in FIG. 7), including the S-p-V (State-policy-Value) results table 700.

A: The likely path 720 from the current shared network and specific states, where likely path is generated using the information set from the composed and solved decision problem, and is based on both the transition probabilities for states and the policy recommendations from the solved problem. For further information on finding the likely path see U.S. Pat. No. 10,460,249.

B: User selectable recommended policies 730, a comparison of current rewards and value calculated for the recommended action and a user-specified alternative policy, using information from the S-p-V table in the solution results, the other elements of the information set, and a comparison-of-value calculation.

C: Elements of the initial information set, such as the reward, costs, and transition probabilities associated with specific actions. Other explanatory information that is part of the information set.

D: Other options for post-solution visualizations include visualizing the network by using the directed graph identified above, including in the directed graph the state and policy portion of the S-p-V table summarizing the solutions.

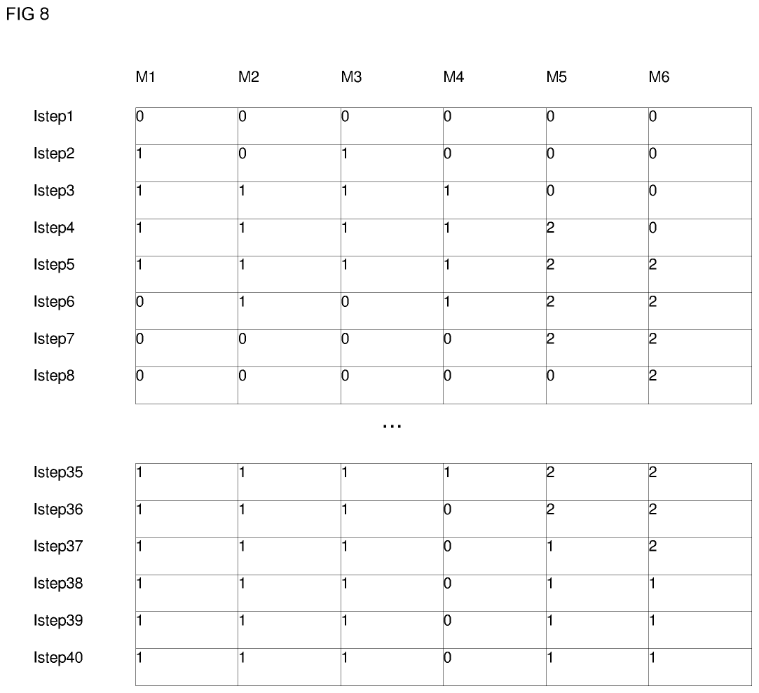

In many embodiment it may be helpful for the specification of the network of machines to take the from of a network inventory, an example inventory is shown in FIG. 8. The network inventory:

1: Identifies each machine in the network

2: Identifies a natural set of “steps” representing a progression of activity within the network, such as the progress of partially-completed products moving down an assembly line consisting of a set of machines.

3: Maps each step in the progression with a specific inventory for each machine on the network.

The Network Inventory may take the form of a table that includes the machines, and the inventory of each machine, at different elements of the state dimension for “inventory” (also known as “steps”). This table may be called a “BigI” table. The table (or another way of storing the data) may take the form of a list, sparse matrix or other form containing the necessary information.

Two key applications of the Big I table are:

1: Using the Big I table to generate the transition probability matrix for the state dimension involving inventory at each machine, using the natural steps as a basis.

2: Using the Big I table to calculate network rewards. The network rewards may be calculated by using the state information represented in the Inventory steps and the Big I table to determine the inventory at the delivery stage, or other stages that generate benefits or costs for the entire network.

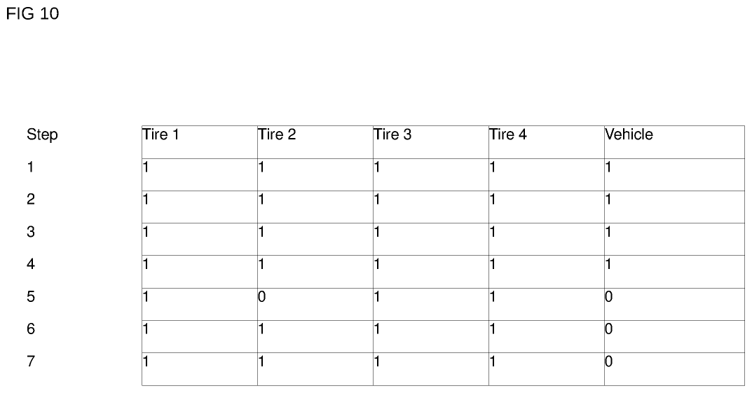

A Big I tables for a network may be illustrated by showing inventory steps in a table, such as shown in FIGS. 10, 12 and 14.

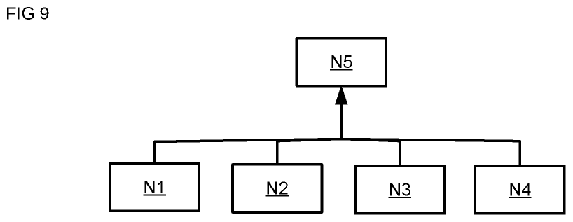

An embodiment for a set of tires on a vehicle is shown in FIG. 9. In this embodiment, shown, there is a set of tires (N1, N2, N3, N4) necessary for the operation of one vehicle (N5). The user is trying to determine a replacement method for a set of four tires on one vehicle. Each tire may be replaced independently of the others, but all four tires must be operational for the vehicle to continue to function.

Additionally, while each tire wears down as the vehicle is used, certain tires may wear down at a faster rate depending on their location on the vehicle. For example, approximately 90% of turns (in a right-hand driving country) will be right hand turns. This may create an asymmetric left versus right wear pattern. Additionally, in a front wheel drive vehicle the front tires (solely responsible for acceleration, and turning and predominately responsible for braking) will wear faster.

The user may be an owner of a large fleet of vehicles, such as a food delivery company or car rental company or only own one or two vehicles. Regardless of how many vehicles the user has, knowing when to replace tires is important for safety, reliability, and cost efficiency.

In this system and method the vehicles tires are described as individual “machines”, and the set of all four tires comprises the network. The operator of the vehicle therefore faces the sequential decision problem of when to replace tires. First the individual SDPs are discussed, then the network SDP is discussed.

The individual SDP involves a single state dimension of tire condition. This may be operationalized as tire wear (as periodically measured with a gauge), tire age, tire distance traveled, visual inspection grading, or some other information that describes the readiness of each of the tires.

A variation of this could involve an additional state dimension or indicator that is used for the purpose of a single state dimension for “condition,” which could arise from data-collection devices in vehicles that report the number of hard-stops or other events or mileage or conditions that affect tire deterioration. We note that adding a dimension to the single-machine replacement problem would not convert this to a network machine replacement problem, or a parallel machine replacement problem

The action set includes operating without any repair or replacement; repair; and replacement. Variations on this could include testing, rotating, cleaning, and other activities.

The transition probabilities along the single state dimension of condition could be determined by experience, or by manufacturer's recommendations, or by regulations based on safety. These would require the eventual replacement of all tires due to their constant deterioration.

The reward function would include the benefits of operating the vehicle (such as the expected gross margin or operating margin from such operation); the costs of repair; and the costs of replacement.

A convenient time index could use units of a week or month if the vehicle is operated regularly. Because all tires, as noted above, have a limit on their operational life-span.

Typical discount and growth rates for business decision problems could also be used.

Using these six elements and presuming reasonable quantities and costs, this individual machine replacement problem could be composed and solved using multiple methods listed in this application, but without the innovation proposed in this application.

Having described the individual SDP the network SDP must also be described. All of the above six elements would be required, with the “condition” dimension of the state being applied to every machine on the network (tire on the vehicle). This is a substantial expansion of the amount of information involved in the problem. For example, the “condition” state dimension for a set of tires on the vehicle must fully describe all possible combinations of “conditions” for all of the tires, instead of merely including four sets of individual tire “conditions”.

An additional state dimension must be added describing the characteristics of the network as a whole. As soon as any tire is repaired, replaced, or fails in service, the entire vehicle moves, at least temporarily, to a non-operational position along this state dimension. This is also a substantial expansion of the amount of information involved in the problem. For example, instead of merely including the operational status of the tire or of a vehicle, considered as a whole, this additional state dimension must fully describe all combinations of states leading to the network being operational or non-operational.

A network reward function would be required, which would make use of the individual machine reward functions, which would become machine output functions. This is also a substantial expansion of the amount of information involved in the problem. For example, the network reward function would incorporate all the individual machine reward functions and map them to all possible reward outcomes, for all possible combinations of the individual machine reward functions.

The action set would expand to include operating the network (vehicle as a whole) and stopping to repair or replace at least one individual machine (tire). The action set could expand to include many combinations of repair and replacement of individual tires or sets of tires.

A network transition probability function would be created. This maps each combination of state and action to a likelihood of a particular subsequent state at the next time increment. For this network transition function, the additional dimensions (including the network characteristic as a whole state dimension) of the network are included, significantly expanding the complexity beyond what would occur for an individual machine transition function.

The first state dimension could be operating status of the network (the operating status of the vehicle as a whole), the second state dimension could be the condition of the machines (the age of each of tires in combination, which could be a very large set of potential state conditions). With these states, for each available action, the transition probability function maps the probability or moving from each state to each state. As an illustration, the vehicle may be in an operating state with four tires in the normal configuration, the front two tires being old, the back two tries being newly replaced, and the action is to “operate.” The most probable transition might be to continued operation, with a small chance of transitioning to state where an old front tire has ceased to function, and an even lower chance that a relatively new rear tire has ceased to function, but with a high chance of the two front tires becoming worn.

In this system and method several of these decision problem elements must be shared across machine problems and the network problem. In this example it is easy to illustrate these shared elements. The time index is shared; the discount rate is shared; the growth rate is shared. Units of cost and wear are shared across the entire problem as well.

The signaling system among the machines and the network operator encompasses the shared network state dimension. In the above example of a vehicle with tires, the direct observation of the driver (noting whether the vehicle is operating, and visually confirming that tires are serviceable or have suffered a failure) could function as the signaling mechanism. In other networks, a mechanical or electronic signaling mechanism can augment this (such as in vehicles with tire pressure monitors); in still others such a mechanism may be the primary signaling mechanism.

The specification of the network structure is shown in FIG. 9 as a directed graph.

The specification of the network forms, in this example, a directed graph with five nodes, one node representing the operational vehicle (N5) and four nodes (N1, N2, N3, N4) representing individual tires. Each tire is connected (through edges) to the vehicle, and the vehicle is dependent on all four tires being operational, but the tires are not operationally dependent on each other. This establishes the location on the network of each tire and the dependency of the vehicle on the four tires.

It is important to note that other equivalent forms and notations may be used to describe the graph of the network, including an adjacency table, a node table, an augmented node table with other state dimensions for each machine, or an inventory table.

An inventory table encodes the following information (shown in FIG. 10):

1: The inventory table identifies each tire within the vehicle.

2: The natural steps representing the progression of activity. In this example all four tires combine in a single step to produce vehicle operation.

3: Maps each step in the progression with a specific inventory for each machine, at different elements of an inventory state dimension. There may be a binary inventory dimension with a location of 1 (operational) or 0 (not operational) for each tire.

The inventory table may take the form of a “Big I” table, with with the initial step being all four tires operational, and a step representing a tire failure as step 5, is shown in FIG. 10. In this embodiment the inventory table may be used to calculate the network rewards, also discussed above, by using the state information represented in the inventory steps and the delivery stage (the vehicle being operational when all four tires are operational).

The signaling system among the machines and the network operator encompasses the shared network state dimension. In the above example of a classic rental car with a three element network state dimension the signaling system may be a daily review of the car before allowing it be rented out for that day.

The structure, error and convergence of the tires (the individual SDPs), and of the vehicle (the network SDP), must be checked, before the network SDP can be solved.

First, the structure of the vehicle network (the four tires coming together to make an operational vehicle) is checked to ensure that there is a valid network structure, including dependencies among the tires. In this case, the following would be checked:

1: Each of the four tires connects to the vehicle as a whole.

2: The operational status of the vehicle depends on the four tires.

3: The four tires are independent of each other.

Second, the network reward function is checked to ensure that is valid, based on the structure of the network (the four tires coming together to make an operational vehicle, including the vehicle being dependent on all four tires being operational) and the rewards arising from each tire being operational.

Next error and convergence checking is performed for the individual tire SDPs is performed, at least in a way analogous to that described in U.S. Pat. No. 9,798,700.

Finally, the convergence of the network of machines is performed, using the output of the convergence checks from the previous step, at least in a way analogous to that described in U.S. Pat. No. 9,798,700.

The vehicle problem is now appropriately composed and ready to be solved. A manner of solving this, consistent with the method stated here, would be the following:

1: Set the shared state characteristics.

2: Solve each tire SDP for its current shared network state (say, vehicle is operational) and the machine-specific states (all have been freshly replaced and have age zero). Collect and report the results tentative state and action information set for each tire.

3: Using the signaling mechanism (the owner checking that each tire is new and operational) communicate this to the other tires. In this case this is just the owner understanding that the vehicle is operational, because all the tires are operational.

4: The user determines the parameters for the solution method, including limits on iterations to be performed and prioritization of solution methods. For example, maybe the owner of the vehicle has a limited time horizon, because the owner routinely sells off vehicles after a specified time frame. Other parameters may be the number of actions to consider or the structure of the network. Perhaps the owner only wants to consider replacing one tire at a time or doing nothing.

5: Solve the vehicle tire management sequential decision problem using one of the solution methods described above, using a solution algorithm described above. Continue solving until a solution is found, a terminal condition is achieved (such as the end of the time period for keeping the vehicle) or the owner stops the system from operating.

6: Report the results of the vehicle tire management sequential decision problem to the owner, including a SPV (“state-policy-value”) table, mapping for each indicated state (condition of the vehicle), the selected action (do nothing, replace a tire, replace all tires) and the value the owner will receive for following the suggested policy.

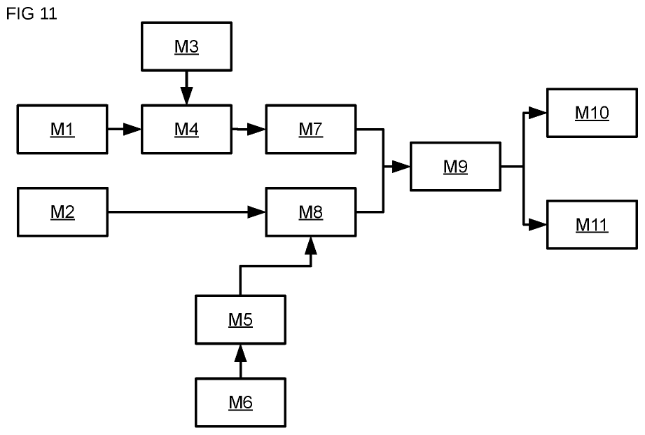

In another embodiment there is a complex multi-feed assembly line, as shown in FIG. 11.

In this embodiment there are multiple initial machines (M1, M2, M3, M6) that come together to process multiple outputs (M10 and M11). This will be discussed in the context of an assembly line for two different variations of an after-market automobile rear-spoiler (also known as an air wing), but it is readily apparent that this may be any part for a product, such as a car, or serve as an example for a much lengthier production line (such as for an entire vehicle or phone). While much of this may be analyzed as discussed above, several particular points are interesting and will be discussed below.

The individual machines may be located on one factory floor, or located far apart. If located on a factory floor they may be connected through standard production line techniques. If located apart (such as having drive-trains assembled in one city and moved via rail to a final assembly plant where they are installed into vehicles) the continued operation of the assembly line will depend on just-in-time production techniques be effectively implemented and maintained.

It is apparent that many manufacturing or assembly lines may be analyzed and improved using this system and method, not just automobile or aeronautical machines. This example discusses an assembly line for automobile airfoils, also referred to as “spoilers”, however it could be readily adapted to a more complicated assembly line for airplane parts, airplanes, consumer goods, industrial machines, or other products or goods produced using assembly lines.

Machines 1 and 2 may be large format aluminum stamping machines. In this example Machine 1 may be stamping rear spoilers for performance vehicles, and Machine 2 is stamping rear spoilers for other, low-performance, vehicles.

The spoilers for performance vehicles stamped by Machine 1 are passed to Machine 4. Machine 4 is additionally fed strengthening struts formed by Machine 3. Machine 3 may be a strengthening strut forming machine or represent a supply of such struts supplied by another department or factory. Machine 4 combines the performance spoilers formed by Machine 1 with the struts from Machine 3 and passes the spoilers to Machine 7. Machine 7 may be a heat-treating station where the performance spoiler, with the struts, is heat-treated to provide improved performance characteristics at high speeds. Machine 7 additionally passes the performance spoilers to Machine 9.

The spoilers for low-performance vehicles stamped by Machine 2 are passed to Machine 8. Machine 8 is also fed from Machine 6 through Machine 5. Machine 5 is a machine, supply or station that provides Machine 6 with a supply of large end-caps for low-performance spoilers. The large end caps provide superior looks and street appeal to the low-performance spoilers, but do not particularly increase the performance characteristics. Machine 6 prepares the end caps for being affixed the spoilers by treating the attachment surfaces and passes the prepared end caps to Machine 8. Machine 8 attaches the end caps to the non-performance spoilers and passes the non-performance spoilers to Machine 9.

Machine 9, taking performance and non-performance spoilers from Machines 7 and 8, prepares and paints the spoilers. This may be a department or a single machine and may include cleaning, de-greasing, pre-treatments and post-treatments such as polishing or waxing. Machine 9 also separates out the performance and non-performance spoilers, sending the performance spoilers to Machine 11 and the non-performance spoilers to Machine 10.

Machine 10 is a non-performance spoiler packaging and output machine. In this machine, which (as with all the machines) may be a department, station, machine or facility, the non-performance spoilers are packaged for shipping, display and sale, in containers that protect them during shipping but allow their individual colors to be seen and which prominently displays the decorative end caps.

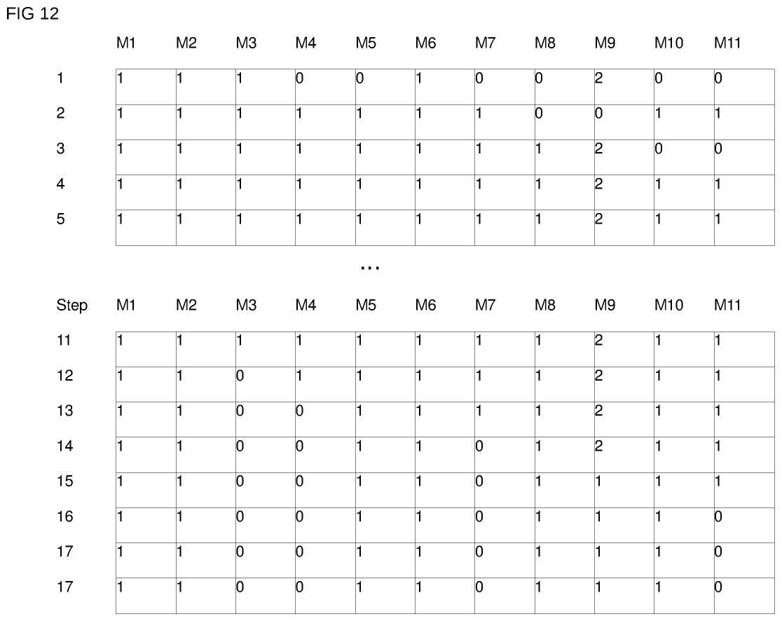

One example inventory table for such an assembly line, shown in FIG. 12 starting from partially operational and proceeding to empty, helpfully encodes inventory information and progression through 5 inventory (operation) steps. This table starts at operational (step 1), then just-in-time procedures break down and Machine 3 runs out of supplies (step 2). The assembly line can still output, but the output of performance spoilers (through Machine 11) trickles off and fails.

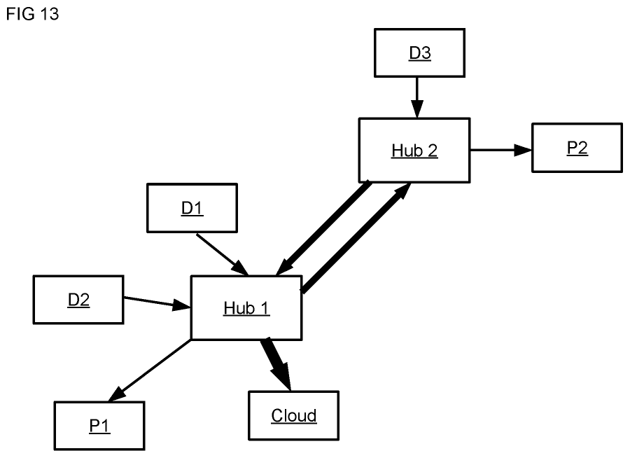

In another embodiment there is a network of computers and related devices as shown in FIG. 13.

This network represents a set of computers, peripherals (such as printers), one or more network hubs, connections (which could be wireless or through wires) among the computers (and potentially some peripherals), and a connection available to one or more of the computers on the network to an outside network. The inside network could be referred to as a LAN (local area network), and the outside network as a WAN (wide area network), the “Cloud” or the Internet. While much of this may be analyzed as discussed above, several particular points are interesting and will be discussed below.

In this representation there are two hubs (Hub 1, Hub 2). There are three machines (D1, D2, D3), which could be computers, laptops, tablets, or mobile devices. There are two peripherals (P1, P2), one of which could be connected to a machine, and one to a hub so as to make it available to every machine on the local network. There is also an access point to a WAN called the “Cloud.”

For computer networks, the “inventory” largely consists of information flows. Blockages and impediments to those information flows commonly arise not from physical wear, but from software bugs, malware, incompatible protocols, operating system changes, and other software related malfunctions, as well as physical anomalies such as power outages, failures of storage drives and broken connections.

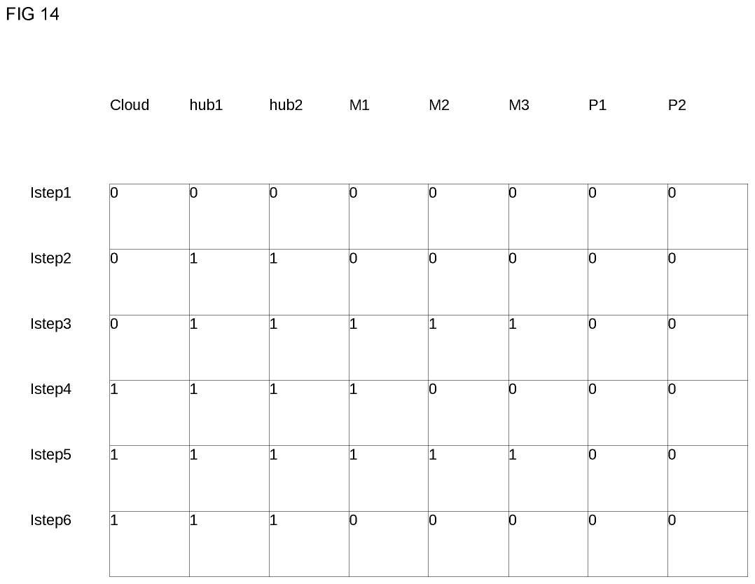

In this embodiment, the inventory table (shown in FIG. 14) represents the ability for information to be generated or received productively by the machine or node on the network, for a variety of situations. A zero indicates an “empty” machine, which could be read as a “dark” spot on the network that was no longer productive. A higher number indicates a larger capacity for information flow.

For hubs that form connections for multiple other nodes, going dark means that the connected machines can no longer communicate properly through that hub. A minimal sample of an Inventory table is shown below, however a full inventory table for such a computer network would be much lengthy than is convenient to printout in this manner. Additionally, it is not necessary for the inventory table entries to be binary. It may be desirable to have fractions or larger integers used. For example, the connection to the “cloud” may operate on a percent basis.

For computer networks the actions available to the decision maker, the network admin, operating company or user, may include to create new connections, close connections, throttle connections, as well replace or services machines. It is important to note that the cost of some of these actions, specifically, creating new connections, may be substantially lower in the computer field than in the manufacturing plant field, this leading to very different policy advice, even for networks that have superficially similar directed graphs.

For computer networks the transition probability function and time index are also likely to be substantially compressed, compared against many other problems such as assembly lines, vehicles or other problems that may be analyzed on a day to day or week to week time scale. A computer network, when the decision maker is attempting to increase the network output, may function on a millisecond time index, with a correspondingly scaled transition probability function.

For computer networks the signaling system may be distributed as software across all, or some of, the nodes on the network. Additionally, the signaling system may take the form of a server or managing computer that, through the various connections, has the ability to control the some or all of the network, or it may simply relay information.

When sequentially solving a computer network it may be important to use, or at least allow for the use of, several different solution methods. While Value Function Iteration and Policy improvement are very powerful, it may be required to employ policy seeking with limits or other iterative or goal seeking algorithms to solve the necessary problems in near-real-time. However, it may not be possible to provide a solution using those methods in near-real-time, so other solutions, such as composite sequential solving or perturbation exploration may be required.

For example, if composite sequential solving is used, the computer network will be divided (using user input or clustering analysis) into two or move sub-networks. In this example D3, P2 and Hub 2 could be analyzed as one sub-network and D1, D2, P1, Cloud and Hub 1 could be analyzed as a second sub-network. Then the innermost portion (D3, P2 and Hub 1) of the composite problem would be solved, using one of the Available Solution Methods listed above. Using this solution as the initial iteration for the value function of the outer portion of the same composite problem (D1, D2, P1, Cloud and Hub 2) the total problem would be solved in the same manner. Then, the process would repeat if improvements in the previous value function are statistically significant.

For the computer network the results could be reported in a table or electronically reported in a graphical display. However, the policy advice could be automatically implemented, by comparing the current network state to the policy advice and selecting the appropriate action, and this process could be repeated. In this way automated flow management across the network could be performed, hardware repairs or updates could be ordered and damaging connections could be throttled or blocked, all without human intervention (or with limited human intervention).

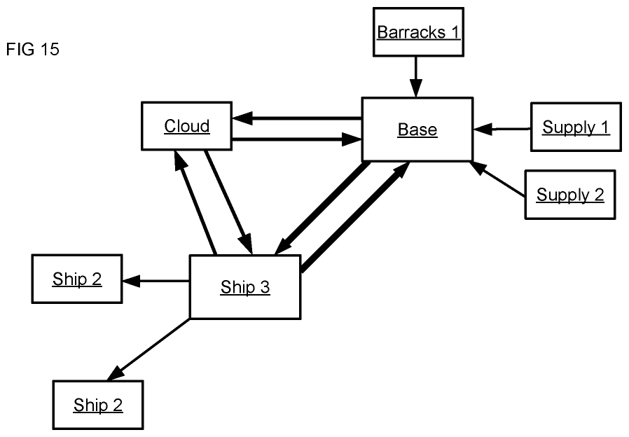

An embodiment based upon a fleet of naval ships shown in FIG. 15 and is used to show the rewards and network management actions of the system and method. The fleet (Ship 1, Ship 2, Ship 3) has one primary ship and two ships providing support to the primary ship. The base (Base) is supplied by a barracks (Barracks 1) and two supply depots (Supply 1 and Supply 2). The communications cloud (Cloud) connects Base to Ship 3, and Ship 3 may also resupply at Base.

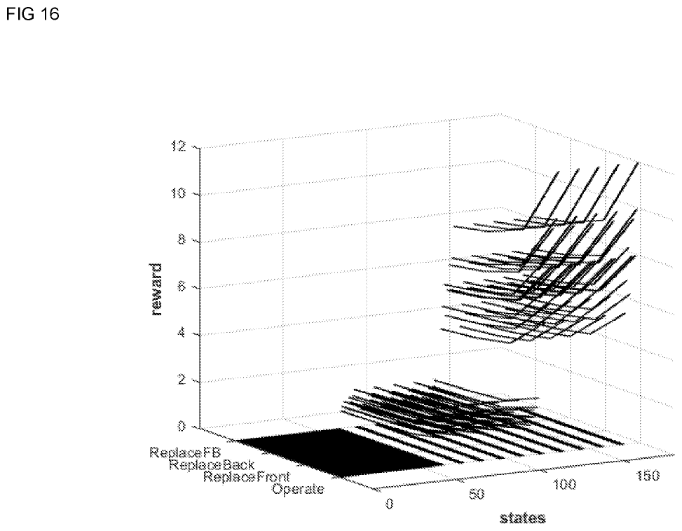

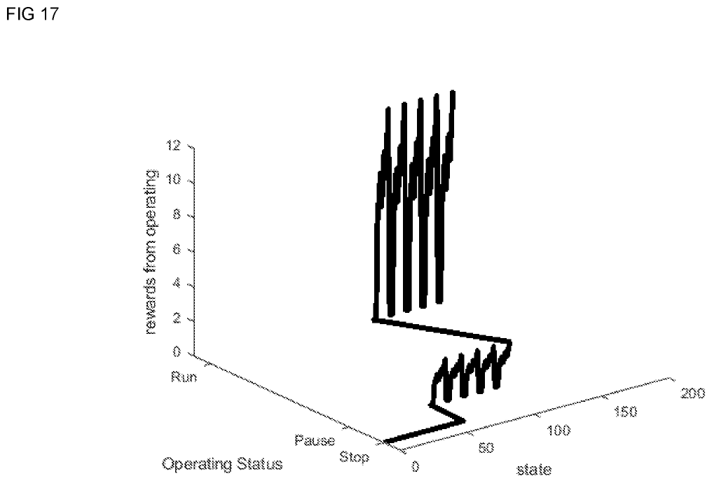

FIG. 16 shows a ribbon graph of rewards versus states, for specified network management actions. There are 4 network management actions available in this embodiment. Operate the fleet (Operate), repair part of the fleet (ReplaceFront), resupply base (ReplaceBack), repair and resupply base and fleet (ReplaceFB). There are also 4 state dimensions. A 1^{st} state dimension represents the operating state of the network (such as running, pausing for repairs or stopping). A 2^{nd} state dimension represents the condition of the machines in the network. A 3^{rd} state dimension represents the inventory levels at each node. A 4^{th} state dimension represents the associated costs. The state dimensions are combined to provide the total set of possible states which are numbered on the graph. Another way to visual the rewards is shown in FIG. 17, a graph of rewards from operation of the network versus states, for 3 operational statuses (Run, Paused for repair of part of the network and Stopped).

I claim:

1: A computer-aided decision-making system, comprising:
a user input device; a user output device; and a processor programmed to evaluate decision problems available to a user; with the programmed processor:
(A) facilitating input of information from the user via the user input device;
(B) defining, from the input information, a sequential decision problem with the subject being a network of machines, with this network-of-machines sequential decision problem having;
(i) a network structure, the network structure having:
(a) a graph of the network having a plurality of nodes and a plurality of edges, establishing the nodes in the network that represent each machine and the location of each machine within the network; and the edges between the nodes that represent directions, magnitudes, and other characteristics of the dependencies among the machines on the network;
(b) at least one network state dimension, the network state dimension representing at least one condition of the nodes on the network;
(c) at least one network management action that changes a characteristic of at least one of the nodes;
(d) a time index, the time index containing decision points available to the user, each decision point representing a point in time when the user selects a network management action;
(e) a network transition function, the network transition function mapping the probability of transitioning between the network state dimensions, given specific network management actions and the directions in the graph of the network;
(f) a signaling system, the signaling system signaling among the machines and the user communicating at least one of the network state dimensions;
(g) a network reward function, the network reward function mapping the network state dimensions, the network management actions, and a set of single machine output functions on the network, to a reward at each decision point that includes all costs and benefits related to the operation of the network;
(ii) a plurality of single machine sequential decision problems, each single machine sequential decision problem representing one or more machines on the network and having;
(a) a set of state dimensions, representing conditions relevant to the relevant single machines, at least one single machine state dimension representing a condition of the relevant single machines,
(b) a set of single machine actions, representing actions available to the operator of the network and affecting one or more single machines, with at least one shared operating status action, the operating status action determining the operating status of the network of machines;
(c) the set of single machine output function mapping the single machine state dimensions and the single machine actions to the output of the machine in that state and under that network management action, the output representing the net benefits received by the operator of the network for each combination of single state dimensions and network management actions;
(iii) the plurality of single machine sequential decision problems all sharing;
(a) a discount factor, the discount factor representing the user's preference for rewards relative to time, and with the discount factor shared among all machines on the network;
(b) the time index contained within the network structure;
(iv) taking the network structure and the plurality of single machine sequential decision problems and composing a separate network-of-machines sequential decision problem;
(C) the single machine sequential decision problems are each individually composed and error-checked and the either network reward function is convergence-checked or the single machine sequential decision problems are each convergence-checked;
(D) the programmed processor further composing the network-of-machines sequential decision problem by identifying;
(i) beginning conditions of each machine in the network and beginning operation status of the network,
(ii) at least one solution method, the solution method selected from a list of available solutions methods, the list consisting of simultaneous network value function iteration, simultaneous network policy improvement, simultaneous network backwards induction, simultaneous network linear programming, simultaneous network integer programming, simultaneous network goal seeking with limits, simultaneous network iterative solving, simultaneous network goal seeking solving, truncated network solving, prioritized sequential machine solving, perturbation exploration, or composite sequential solving, the at least one solution method selected by the user or determined heuristically based on error and convergence checking among available solution methods for methods and selecting at least one method;
(iii) a set of solution method parameters (by user input or default settings), the set of solution method parameters consisting of convergence parameters and (when appropriate to the solution method) iteration limits, the solution method parameters used to find convergence testing results, and;
(E) with the programmed processor subsequently seeking a solution to the network-of-machines sequential decision problem by:
(i) attempting one or more solution methods until the problem is solved, or
(ii) a terminal condition is reached, the terminal condition being a user input condition such as a number of iterations or solution methods to attempt, or
(iii) a further user input to stop or a user input condition specific stop condition is reached; and
(F) after seeking a solution, the programmed processor subsequently:
(i) generating a summary of the solution, which includes a state-policy-value table, the state-policy-value table indicating, for each state, the action the user should select in that state and an indicated value representing the expected reward received by the user received for taking the indicated action; or
(ii) alternatively, indicating the results of the attempts of finding a solution and the outcome of these attempts, which can optionally include information on the solution method, solution parameters, terminal conditions or iteration limits used in the attempts.

2: A computer-aided decision-making system according to claim 1 wherein the programmed processor both convergence checks each single machine sequential decision problem and the network reward function.

3: A computer-aided decision-making system according to claim 1, wherein the programmed processor
(A) forms an inventory table, the inventory table formed from inventory information about each node in the network structure and the graph of the network, the inventory table mapping each possible progression through the network to the inventory state dimension;
(B) uses the inventory table to construct the network reward function.

4: A computer-aided decision-making system according to claim 1, wherein the programmed processor allows the user to select individual machines, states or specific network management or machine actions and to output the state-policy-value table only for the selection.

5: A computer-aided decision-making system according to claim 1, wherein the programmed processor calculates at least one likely path for the network of machines sequential decision problem, the at least one likely path representing one or more of the most probable path for a selected beginning state, the most probable and second most probably path for a selected beginning state, a selected number of probable paths for a selected beginning state, a probably path based upon user-provided path selection criteria.

6: A computer-aided decision-making system according to claim 1, wherein the programmed processor calculates at least one likely path for a user selected machine, the at least one likely path representing one or more of the most probable path for a selected beginning state, the most probable and second most probably path for a selected beginning state, a selected number of probable paths for a selected beginning state, a probably path based upon user-provided path selection criteria.

7: A computer-aided decision-making system according to claim 3, wherein the programmed processor receives a network structure having representing tires and wheels on a vehicle, and an additional node representing the vehicle the operational status of the vehicle, the vehicle operating to produce rewards for the user.

8: A computer-aided decision-making system according to claim 3, wherein the programmed processor receives a network structure having a plurality of sets of nodes, each set of nodes representing at least one machine on an assembly line, the plurality of sets of nodes overall representing a multi-feed assembly line, the assembly line operating to produce rewards for the user.

9: A computer-aided decision-making system according to claim 3, wherein the programmed processor receives a network structure having a plurality of nodes, each node representing a device on a computer network, the computer network operating to produce rewards for the user.

10: A computer-aided decision-making system according to claim 8, wherein the programmed processor calculates at least one likely path for the network of machines sequential decision problem, the at least one likely path representing one or more of the most probable path for a selected beginning state, the most probable and second most probably path for a selected beginning state, a selected number of probable paths for a selected beginning state, a probably path based upon user-provided path selection criteria.

11: A computer-aided decision-making system according to claim 9, wherein the programmed processor calculates at least one likely path for a user selected machine, the at least one likely path representing one or more of the most probable path for a selected beginning state, the most probable and second most probably path for a selected beginning state, a selected number of probable paths for a selected beginning state, a probably path based upon user-provided path selection criteria.

12: A computer-aided decision-making system according to claim 3, wherein the programmed processor receives a network structure having nodes representing ships or land-based units, bases, supply depots or barracks, satellite or cloud-based servers, and the network of all these units operating to produce rewards for the user, where the user is a country and the network representing a navy, army, air force, or other military task force or contingent of the country.

13: A computer implemented method for assisting a user in making a decision comprising:
providing a user input device; a user output device; and a processor programmed to evaluate decision problems available to a user; with the programmed processor:
(A) facilitating using the computer system input of information from the user via the user input device;
(B) defining using the computer system, from the input information, a sequential decision problem with the subject being a network of machines, with this network-of-machines sequential decision problem having;
(i) a network structure, the network structure having:
(a) a graph of the network having a plurality of nodes and a plurality of edges, establishing the nodes in the network that represent each machine and the location of each machine within the network; and the edges between the nodes that represent directions, magnitudes, and other characteristics of the dependencies among the machines on the network;
(b) at least one network state dimension, the network state dimension representing at least one condition of the nodes on the network;
(c) at least one network management action that changes a characteristic of at least one of the nodes;
(d) a time index, the time index containing decision points available to the user, each decision point representing a point in time when the user selects a network management action;
(e) a network transition function, the network transition function mapping the probability of transitioning between the network state dimensions, given specific network management actions and the directions in the graph of the network;
(f) a signaling system, the signaling system signaling among the machines and the user communicating at least one of the network state dimensions;
(g) a network reward function, the network reward function mapping the network state dimensions, the network management actions, and a set of single machine output functions on the network, to a reward at each decision point that includes all costs and benefits related to the operation of the network;
(ii) a plurality of single machine sequential decision problems, each single machine sequential decision problem representing one or more machines on the network and having;
(a) a set of state dimensions, representing conditions relevant to the relevant single machines, at least one single machine state dimension representing a condition of the relevant single machines,
(b) a set of single machine actions, representing actions available to the operator of the network and affecting one or more single machines, with at least one shared operating status action, the operating status action determining the operating status of the network of machines;
(c) the set of single machine output function mapping the single machine state dimensions and the single machine actions to the output of the machine in that state and under that network management action, the output representing the net benefits received by the operator of the network for each combination of single state dimensions and network management actions;
(iii) the plurality of single machine sequential decision problems all sharing;
(c) a discount factor, the discount factor representing the user's preference for rewards relative to time, and with the discount factor shared among all machines on the network;
(d) the time index contained within the network structure;
(iv) taking the network structure and the plurality of single machine sequential decision problems and composing a separate network-of-machines sequential decision problem;
(C) using the computer system the single machine sequential decision problems are each individually composed and error-checked and the either network reward function is convergence-checked or the single machine sequential decision problems are each convergence-checked;
(D) using the computer system the programmed processor further composing the network-of-machines sequential decision problem by identifying;
(iv) beginning conditions of each machine in the network and beginning operation status of the network,
(v) at least one solution method, the solution method selected from a list of available solutions methods, the list consisting of simultaneous network value function iteration, simultaneous network policy improvement, simultaneous network backwards induction, simultaneous network linear programming, simultaneous network integer programming, simultaneous network goal seeking with limits, simultaneous network iterative solving, simultaneous network goal seeking solving, truncated network solving, prioritized sequential machine solving, perturbation exploration, or composite sequential solving, the at least one solution method selected by the user or determined heuristically based on error and convergence checking among available solution methods for methods and selecting at least one method;
(vi) a set of solution method parameters (by user input or default settings), the set of solution method parameters consisting of convergence parameters and (when appropriate to the solution method) iteration limits, the solution method parameters used to find convergence testing results, and;
(E) then using the computer system the programmed processor subsequently seeks a solution to the network-of-machines sequential decision problem by:
(iv) attempting one or more solution methods until the problem is solved, or
(v) a terminal condition is reached, the terminal condition being a user input condition such as a number of iterations or solution methods to attempt, or
(vi) a further user input to stop or a user input condition specific stop condition is reached; and
(F) then using the computer system after seeking a solution, the programmed processor subsequently:
(iii) generating a summary of the solution, which includes a state-policy-value table, the state-policy-value table indicating, for each state, the action the user should select in that state and an indicated value representing the expected reward received by the user received for taking the indicated action; or
(iv) alternatively, indicating the results of the attempts of finding a solution and the outcome of these attempts, which can optionally include information on the solution method, solution parameters, terminal conditions or iteration limits used in the attempts.

14: A computer implemented method for assisting a user in making a decision according to claim 13 wherein, using the computer system, the programmed processor both convergence checks each single machine sequential decision problem and the network reward function.

15: A computer implemented method for assisting a user in making a decision according to claim 13 wherein, using the computer system, the programmed processor
(A) forms an inventory table, the inventory table formed from inventory information about each node in the network structure and the graph of the network, the inventory table mapping each possible progression through the network to the inventory state dimension;
(B) uses the inventory table to construct the network reward function.

16: A computer implemented method for assisting a user in making a decision according to claim 13 wherein, using the computer system, the programmed processor processor allows the user to select individual machines, states or specific network management or machine actions and to output the state-policy-value table only for the selection.

17: A computer implemented method for assisting a user in making a decision according to claim 13 wherein, using the computer system, the programmed processor calculates at least one likely path for the network of machines sequential decision problem, the at least one likely path representing one or more of the most probable path for a selected beginning state, the most probable and second most probably path for a selected beginning state, a selected number of probable paths for a selected beginning state, a probably path based upon user-provided path selection criteria.

18: A computer implemented method for assisting a user in making a decision according to claim 13 wherein, using the computer system, the programmed processor calculates at least one likely path for a user selected machine, the at least one likely path representing one or more of the most probable path for a selected beginning state, the most probable and second most probably path for a selected beginning state, a selected number of probable paths for a selected beginning state, a probably path based upon user-provided path selection criteria.

19: A computer implemented method for assisting a user in making a decision according to claim 15 wherein, using the computer system, the programmed processor receives a network structure having representing tires and wheels on a vehicle, and an additional node representing the vehicle the operational status of the vehicle, the vehicle operating to produce rewards for the user.

20: A computer implemented method for assisting a user in making a decision according to claim 15 wherein, using the computer system, the programmed processor receives a network structure having a plurality of sets of nodes, each set of nodes representing at least one machine on an assembly line, the plurality of sets of nodes overall representing a multi-feed assembly line, the assembly line operating to produce rewards for the user.

21: A computer implemented method for assisting a user in making a decision according to claim 15 wherein, using the computer system, the programmed processor receives a network structure having a plurality of nodes, each node representing a device on a computer network, the computer network operating to produce rewards for the user.

22: A computer implemented method for assisting a user in making a decision according to claim 20 wherein, using the computer system, the programmed processor calculates at least one likely path for the network of machines sequential decision problem, the at least one likely path representing one or more of the most probable path for a selected beginning state, the most probable and second most probably path for a selected beginning state, a selected number of probable paths for a selected beginning state, a probably path based upon user-provided path selection criteria.

23: A computer implemented method for assisting a user in making a decision according to claim 21 wherein, using the computer system, the programmed processor calculates at least one likely path for a user selected machine, the at least one likely path representing one or more of the most probable path for a selected beginning state, the most probable and second most probably path for a selected beginning state, a selected number of probable paths for a selected beginning state, a probably path based upon user-provided path selection criteria.

24: A computer implemented method for assisting a user in making a decision according to claim 15, wherein, using the computer system, the programmed processor receives a network structure having nodes representing ships or land-based units, bases, supply depots or barracks, satellite or cloud-based servers, and the network of all these units operating to produce rewards for the user, where the user is a country and the network representing a navy, army, air force, or other military task force or contingent of the country.
